(19) United States
(12) Patent Application Publication
(10) Pub. No.: US 2013/0015371 A1
(43) Pub. Date: Jan. 17, 2013

(54) THERMOLUMINESCENT COMPUTED RADIOGRAPHY READER AND METHOD FOR USING SAME

(71) Applicants: Clifford Bueno, Clifton Park, NY (US); Manoharan Venugopal, Bangalore (IN); Jeffrey Jon Shaw, Ballston Lake, NY (US); Mark John Osterlitz, Schenectady, NY (US)

(72) Inventors: Clifford Bueno, Clifton Park, NY (US); Manoharan Venugopal, Bangalore (IN); Jeffrey Jon Shaw, Ballston Lake, NY (US); Mark John Osterlitz, Schenectady, NY (US)

(73) Assignee: GENERAL ELECTRIC COMPANY, Schenectady, NY (US)

(21) Appl. No.: 13/179,584

(22) Filed: Jul. 11, 2011

(51) Int. Cl. G03B 42/08

(52) U.S. Cl. 250/473.1; 250/484.3

(57) ABSTRACT

A computed radiography reading system and method. The system includes an exposed computed radiography plate, a two-dimensional pixelized array, and a heating element. The heating element conducts heat to the computed radiography plate and the computed radiography plate releases entrained light signals to the two-dimensional pixelized array in response to the conducted heat.

### FIELD

The invention relates to a computed radiography reading system and method, and more particularly, to a computed radiography reading system and method utilizing thermoluminescence to read an image.

### BACKGROUND

Radiography is an imaging technique that uses X-rays to view non-uniformly composed material, such as, for example, a human body. By projecting a heterogeneous beam of X-rays produced by an X-ray source at an object, an image of the object can be developed that clearly displays areas of differing density and composition. Based upon the density and composition of the differing areas of the object, some portion of the projected X-rays is absorbed by the object. The X-rays that pass through are then captured behind the object by a detector—a film sensitive to X-rays—which will create a two-dimensional representation of all the object's structures superimposed on each other.

Computed radiography is one form of radiography and uses similar equipment to conventional radiography except that in place of film to create an image, an imaging plate formed of a photostimulable phosphor is used. The imaging plate is generally housed in a special cassette that is placed under the object to be examined and the X-ray exposure is performed. The imaging plate is run through a special laser scanner, or computed radiography (CR) reader. The CR reader reads and digitizes the image. The digitized image can be viewed and enhanced using software that has functions similarly to other conventional digital image processing software, such as, for example, contrast, brightness, filtration, and zoom. Unlike film, a CR reader or CR imaging plate can be completely optically erased of all image content following a read, making it ready for reuse.

Digital radiography is an offshoot of computed radiography. Instead of a cassette housing an imaging plate, digital radiography typically captures an image directly onto a pixelized imaging device through the use of a scintillator or photoconductor, which captures the X-ray pattern, and a subsequent image transfer component to the pixel imaging device.

FIG. 1 illustrates a conventional computed radiography scanning system 10. The CR scanning system 10 includes a light source 16, an exposed computed radiography plate 12, a photomultiplier 42, and a processor 24. Specifically, an optical pump source 16 produces light to be delivered to the CR plate 12 to generate phosphorescence in response to a latent X-ray image formed therein. The pumped light is carried to the vicinity of the CR plate 12 by a plurality of optical fibers 18. It should be appreciated that the optical pump source 16 may include a laser that provides the photo stimulation.

A housing holds and defines a light-tight enclosure 14, which holds the exposed computed radiography plate 12 during a scanning operation. Also within the housing are the processor 24 and a display 30. The processor 24 controls the operation of the optical pump source 16 through a multiplexer 32. Specifically, the multiplexer 32, under direction from the processor 24, selectively energizes a red light-emitting diode 34, an infrared light-emitting diode 36, and a blue light-emitting diode 38. The multiplexer 32 can energize the diodes 34, 36, 38 one at a time or simultaneously. The purpose of energizing the diodes 34, 36, 38 is to transmit light to a lensing body 40 of the plurality of optical fibers 18 for delivery to the CR plate 12. A stepper motor 50 moves the CR plate 12 past the optical fibers 18, 20 to be scanned.

Phosphorescent blue light is emitted from the CR plate 12 and is captured in the second plurality of optical fibers 20. Alternatively, a light pipe can be used in place of the optical fibers 20. An optical receiver 22, including the photomultiplier 42, converts the phosphorescent light received from the optical fibers 20 to an electrical image signal. An operational amplifier amplifies the electrical image signal and feeds an amplified analog received phosphorescent light signal to an analog-to-digital converter 46, which provides a digital output signal.

U.S. Pat. No. 6,894,303, entitled Method and Apparatus for Radiographic Imaging, provides more detailed information regarding the computed radiography scanning system of FIG. 1.

FIG. 2 illustrates a known two-dimensional computed radiography scanning system 110. The CR scanning system 110 includes a radiation source 111, a computed radiography (CR) plate 112, an illumination source 116, and a two-dimensional imager 144. The radiation source 111 may be, for example, an X-ray source or a gamma-ray source. The radiation source 111 passes X-rays (or gamma-rays) through an object 115 and irradiates the CR plate 112, which stores radiation energy from the radiation source 111. The illumination source 116, which may be a laser or a broad illumination source such as a xenon lamp with a red pas filter, illuminates a portion of the CR plate 112 and stimulates the emission of photons corresponding to trapped X-ray energy in the CR plate 112.

The two-dimensional imager 144—which may be a solid-state camera, a charge coupled device (CCD) camera, a complementary metal oxide semiconductor (CMOS) camera, or a charge injection device (CID) camera—captures a two-dimensional image using the stimulated emission photons from the CR plate 112.

A dichroic filter 135 is positioned between the illumination source 116 and the CR plate 112. The dichroic filter 135 passes stimulating illumination from the illumination source 116 to the CR plate 112 and reflects stimulated emission photons from the CR plate 112. The two-dimensional imager 144 is configured to receive the stimulated emission photons reflected by the dichroic filter 135. A blue pass filter 138 may be disposed between the dichroic filter 135 and the two-dimensional imager 144 to filter the illumination and allow passage of only desirable stimulated blue light from the CR plate 112.

A lens system 140 is operatively connected to the two-dimensional imager 144 and may include a multi-element lens, a spatial imaging lens, a zoom lens, or a high transmission lens. The lens system 140 and the two-dimensional imager 144 may be controlled by a controller 124. Specifically, the controller 124 may direct the lens system 140 and the two-dimensional imager 144 to read out a region of interest on the CR plate 112 to perform sub-array imaging. A translation means 150 is used to move the two-dimensional imager 144 and focus the lens system 140, and it may be controlled by the controller 124.

U.S. Pat. No. 7,244,955, entitled Computed Radiography Systems and Methods of Use, and assigned to assignee of the instant patent application provides more detailed information regarding the computed radiography scanning system of FIG. 2.

A disadvantage encountered with systems like those represented in FIG. 1 is related to the need to move either the CR plate or the imaging device. Movement of the CR plate, such as CR plate 12, by a movement means, such as stepper motor 50 (FIG. 1), can damage the CR plate 12. To read the CR plate 12, the illuminating device, usually a laser, is rastered across the plate using a galvanic minor or a rotating mirror to read a line on the plate. Then, the plate is translated in a second direction, substantially orthogonal to the first direction, so that the illuminating device can read additional lines on the CR plate 12. Rastering of the illuminating device expends much time. For example, if the reading of a single line of a CR plate 12 takes five milliseconds, and there are 4,000 lines to be read in the CR plate, it will take 20,000 milliseconds, or 20 seconds, to read the entire plate. Further, while correction software is available to correct for artifacts that occur during the movement of the CR plate 12 in the first direction, no such correction software has been typically employed to correct for artifacts that occur during the translation of the CR plate 12 in the second direction.

Another disadvantage encountered with systems like the ones represented in FIGS. 1 and 2 is that much of the energy trapped within the CR plates is not released through the photo stimulation. Energy that is not released must be erased post-scan, adding an additional step in the process. Energy that is not released is energy that is wasted, whether it is energy for a delivered dose to a patient or energy for a delivered scan in an industrial or security inspection. Regardless of the application, CR plates must be exposed to a radiation dose large enough for the scanners to be able to obtain a signal in the same time frame that the laser dwells on each individual pixel. This leaves residual stored energy in the imaging plate that is then wasted as the machine cannot dwell long enough on each pixelized region to abstract the entire amount of the energy. Using excessive radiation doses can impact patient health. Extending exposure times can lengthen the time for throughput of the inspection process.

Further, managing ambient radiation levels becomes problematic with longer exposure times. Longer exposure times may lead to certain safety thresholds being exceeded. Alternatively, longer exposure times may lead to the need for costly, heavier shielding to maintain safe radiation rates and achieve safe operation and a safe total ambient exposure to personnel in the area of the examinations.

With some of these concerns in mind, a thermoluminescent computed radiography reader would be welcome in the art.

### SUMMARY

An embodiment of the invention includes a computed radiography reading system that includes an exposed computed radiography plate, a two-dimensional pixelized array, and a heating element. The heating element conducts heat to the computed radiography plate and the computed radiography plate releases entrained light signals to the two-dimensional pixelized array in response to the conducted heat.

An aspect of the embodiment includes a hinge, wherein the heating element is mounted on the hinge.

An embodiment of the invention includes a thermoluminescent computed radiography reading system that includes an exposed, flexible, thermoluminescent computed radiography phosphor, an amorphous silicon based two-dimensional pixelized array, and a heating element, wherein the heating element conducts heat to the computed radiography phosphor and the computed radiography phosphor releases entrained light signals to the two-dimensional pixelized array in response to the conducted heat.

An embodiment of the invention includes a method. The method includes placing an exposed computed radiography plate near to a two-dimensional pixelized array and a heating element, conducting heat toward the exposed computed radiography plate to release trapped light from the exposed computed radiography plate, and receiving the released light in the two-dimensional pixelized array to store an image therein.

An aspect of the embodiment includes correcting for variations in the digitized image. The correcting includes creating an offset image, creating a blank image with an unexposed computed radiography plate without an object, digitizing the offset and blank images, subtracting the digitized offset image from the digitized image to form a digitized offset corrected object image, subtracting the digitized offset image from the digitized blank image to form a digitized offset corrected blank image, and dividing the digitized offset corrected object image by the digitized offset corrected blank image to form a finalized digitized image.

These and other features, aspects and advantages of the present invention may be further understood and/or illustrated when the following detailed description is considered along with the attached drawings.

### DESCRIPTION OF THE DRAWINGS

FIG. 1 is a schematic view of a conventional computed radiography scanner.

FIG. 2 is a schematic view of a conventional computed radiography scanner.

FIG. 3 is a schematic view of thermoluminescent computed radiography reader in accordance with an embodiment of the invention.

FIG. 4 is a schematic view of thermoluminescent computed radiography reader in accordance with an embodiment of the invention.

FIG. 5 is a schematic view of thermoluminescent computed radiography reader in accordance with an embodiment of the invention.

FIG. 6 is a schematic view of thermoluminescent computed radiography reader in accordance with an embodiment of the invention.

FIG. 7 is a schematic view of thermoluminescent computed radiography reader in accordance with an embodiment of the invention.

FIG. 8 illustrates process steps for correcting for artifacts in images in accordance with an embodiment of the invention.

FIG. 9 illustrates process steps for obtaining a computed radiography image through thermoluminescence in accordance with an embodiment of the invention.

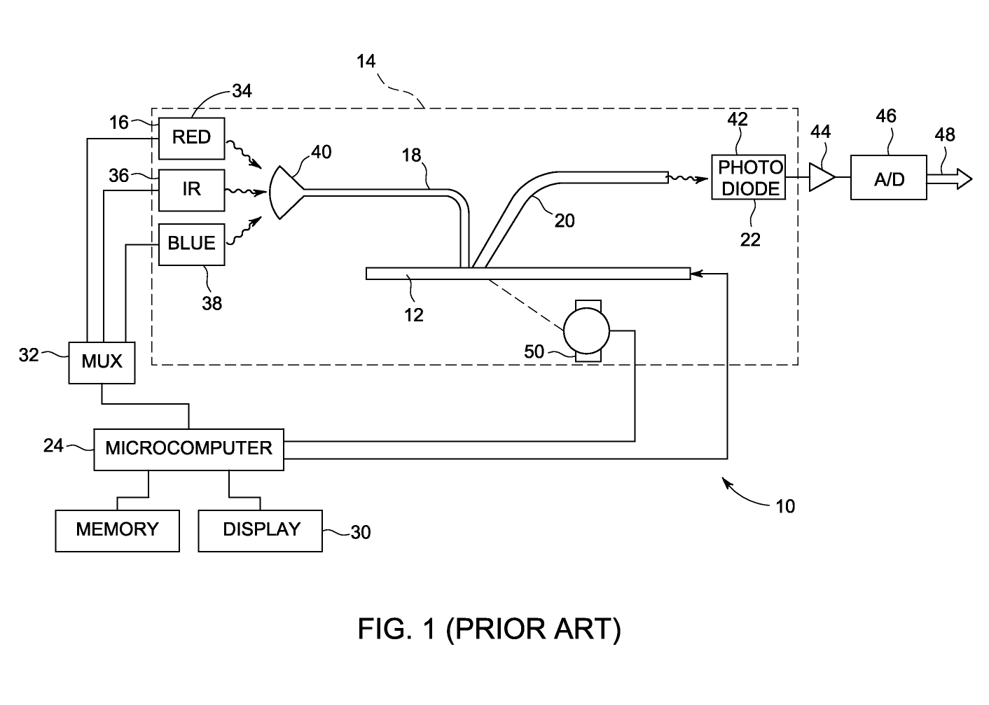

### DETAILED DESCRIPTION

The present specification provides certain definitions and methods to better define the embodiments and aspects of the invention and to guide those of ordinary skill in the art in the practice of its fabrication. Provision, or lack of the provision, of a definition for a particular term or phrase is not meant to imply any particular importance, or lack thereof; rather, and unless otherwise noted, terms are to be understood according to conventional usage by those of ordinary skill in the relevant art.

Unless defined otherwise, technical and scientific terms used herein have the same meaning as is commonly understood by one of skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about μwt. %, or, more specifically, about 5 wt. % to about 20 wt. %,” is inclusive of the endpoints and all intermediate values of the ranges of “about 5 wt. % to about 25 wt. %,” etc.).

The modifier “about” used in connection with a quantity is inclusive of the stated value and has the meaning dictated by the context (e.g., includes the degree of error associated with measurement of the particular quantity). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described inventive features may be combined in any suitable manner in the various embodiments.

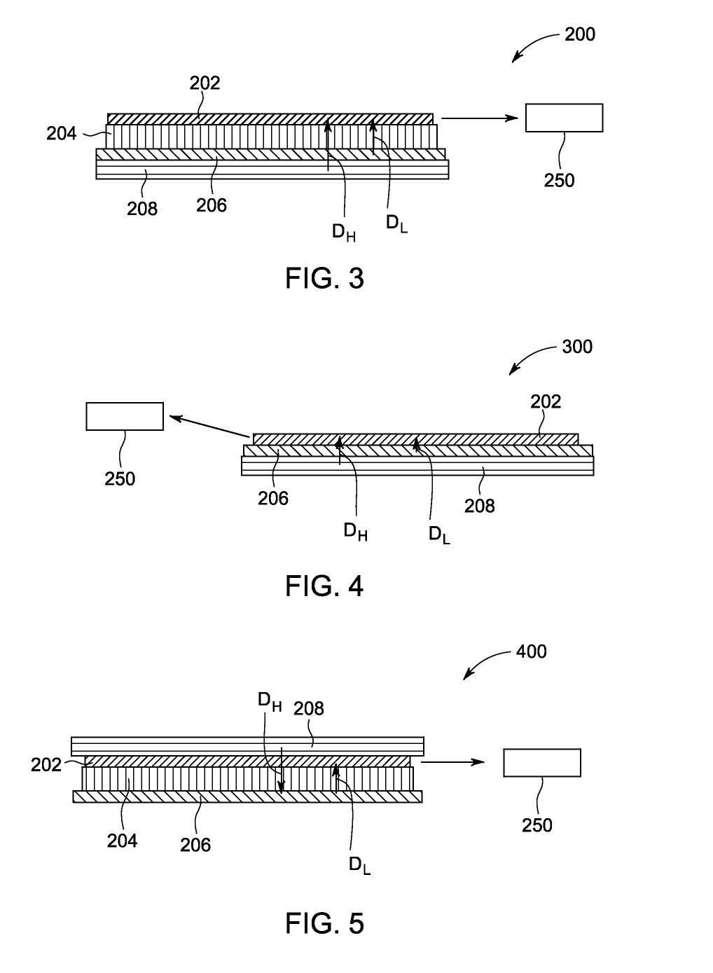

FIG. 3 illustrates a thermoluminescent computed radiography reading system 200 in accordance with an embodiment of the invention. The system 200 includes a two-dimensional pixelized array 202 supported by a fiber optic face plate 204. The fiber optic face plate 204 is situated over an exposed computed radiography (CR) plate 206, which itself sits on a heating element 208.

The heating element 208 can be any suitable heat conducting system or device, including, for example, a hot plate, a polyimide insulated heater, such as a Kapton® heater. Suitable heat conducting systems or devices need to provide heat across a two-dimensional area with uniformity. Heaters that provide uniform heat themselves across a two-dimensional area will be suitable as a heating element 208. Furthermore, non-uniform heaters may be paired up with conductors that conduct heat uniformly. For example, a half-inch plate of copper can be paired up with a non-uniform heater to form a uniform heat conducting system suitable as a heating element 208.

The CR plate 206 may be formed of a heat tolerant, flexible thermoluminescent computed radiography phosphor. The CR plate 206 already has a latent image trapped within it. To be able to read the latent image, heat from the heating element 208 is conducted to the CR plate 206. The heat releases the latent image as light that is trapped within the CR plate 206. It should be understood that each phosphor material has its own thermoluminescent glow curves that are typically broad with respect to the temperature needed to release latent energy. The closer the temperature is to the peak of the glow curve, the faster light is emitted from the phosphor. Some thermoluminescent materials will not emit if a certain threshold temperature is not obtained. With other thermoluminescent materials, if light is rapidly emitted then the temperature may be too high, leading to a waste of energy to use such power to heat that style of image plate. It should further be understood that some of the light can be unleashed at a relatively low temperature, whereas other light may be trapped deeper within the CR plate 206 and it takes higher temperatures to release that light. This is termed bimodal emission. Thus, the glow curve—a graphic representation of an emitted light intensity that increases with an increasing phosphor temperature—will spike at a lower temperature and also at a higher temperature.

The fiber optic face plate 204 is sized and configured to receive released light from the CR plate 206 and transmit that light to the photodiode 202. The fiber optic face plate 204 is formed of materials that can withstand the elevated temperatures of the heating element 208. Examples of suitable materials for the fiber optic face plate 204 include silicate glass.

The two-dimensional pixelized array 202 may be formed of an amorphous silicon material or crystalline silicon material. The two-dimensional pixelized array 202 may be a large-area flat panel amorphous-silicon based image sensor. Currently, amorphous silicon panels may range in size up to 16 inch×16 inch, with individual pixel sizes of approximately 200 μm. Amorphous silicon material can withstand temperatures up to about 150 to 200° C. Current crystalline silicon panels, for example, tiled CMOS panels, are typically smaller, ranging in size around 50×50 millimeters square, with individual pixel sizes of approximately 50 μm. Both amorphous silicon material and crystalline silicon material panels also may be tiled to form larger arrays.

In operation, the heating element 208 conducts heat in a direction D_{H} to the CR plate 206. The heat serves to unlock the latent image in the CR plate 206, essentially developing the image so that it can be read and digitized by the two-dimensional pixelized array 202. As the heat unlocks the latent images in the CR plate 206, light from the CR plate 206 corresponding to the latent images is transmitted in a direction D_{L} through the fiber optic face plate 204 to the two-dimensional pixelized array 202. The two-dimensional pixelized array 202 essentially performs a two-dimensional reading of the light signals transmitted by the CR plate 206. This two-dimensional reading is much faster than the one-dimensional laser scanning found in conventional CR systems.

FIG. 4 illustrates a thermoluminescent computed radiography reading system 300 in accordance with an embodiment of the invention. The system 300 differs from the thermoluminescent computed radiography scanning system 200 of FIG. 3 in that it lacks a fiber optic face plate. Instead, the two-dimensional pixelized array 202 rests on top of the CR plate 206. Direct contact between the CR plate 206 and the two-dimensional pixelized array 202 provides the most efficient arrangement for transferring released light, which is transmitted in direction D_{L} from the CR plate 206 directly into the two-dimensional pixelized array 202. This results in the highest capture efficiency possible from a phosphor plate in contact with a two-dimensional pixelized array. Note that amorphous silicon panels may be heat tolerant in that they are not damaged at the temperatures mentioned above through direct interaction with the heat source. However, their offset values will migrate higher, and will diminish the dynamic range of the two-dimensional pixelized array. Correction of the higher offset values must then be accounted for at the higher temperature for both the blank and object X-ray images

FIG. 5 illustrates a thermoluminescent computed radiography reading system 400 in accordance with an embodiment of the invention. This system 400 differs from the thermoluminescent computed radiography scanning system 200 of FIG. 3 in that the heating element 208 rests on top of the two-dimensional pixelized array 202. With this arrangement, the heat travels in direction D_{H} through the two-dimensional pixelized array 202 and the fiber optic face plate 204 before striking the CR plate 206. This arrangement has a further advantage of being able to utilize the fiber optic face plate 204 to provide further uniformity to the heating of the CR plate 206.

Then, as the heat releases light from the exposed CR plate 206, the light travels back in a direction D_{L} substantially opposite from the direction D_{H} of heat, through the fiber optic face plate 204 to the two-dimensional pixelized array 202. It should be appreciated that the fiber optic face plate 204 should be thin enough so as to allow a majority of the heat from the heating element 208 to be conducted in a uniform manner to the CR plate 206.

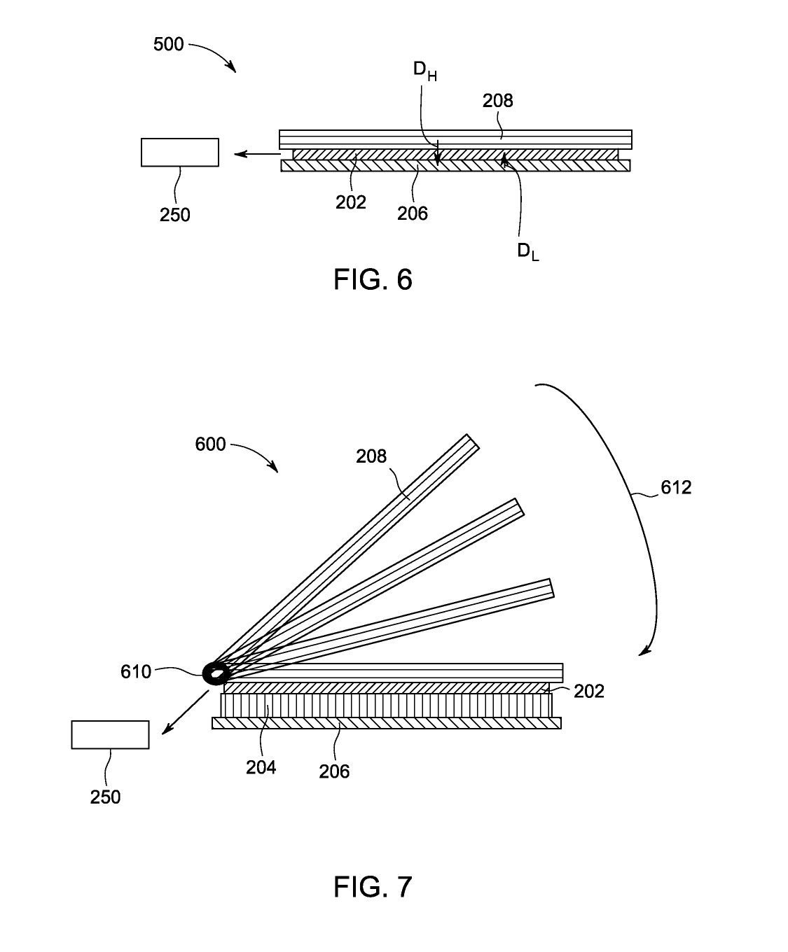

FIG. 6 illustrates a thermoluminescent computed radiography reading system 500 in accordance with an embodiment of the invention. The system 500 differs from the thermoluminescent computed radiography scanning system 400 of FIG. 5 in that it lacks a fiber optic face plate. To protect the reusable two-dimensional pixelized array 202 from becoming scratched through its placement between the CR plate 206 and the heating element 208, a protective coating is applied to the two-dimensional pixelized array 202. The protective coating may be a scratch resistant coating typically used on the faces of optical components, such as the face of personal digital assistants (PDAs) and the like.

It should be appreciated that the arrangements as described in FIGS. 5 and 6 may be inverted, with the heating element 208 on the bottom and the CR plate 206 on top. In such an arrangement, a weight placed on the CR plate 206 will enable a more light-tight enclosure, ensuring that light traveling from the CR plate 206 to the two-dimensional pixelized array 202 is less likely to bleed out.

FIG. 7 schematically illustrates a thermoluminescent computed radiography reading system 600 in accordance with an embodiment of the invention. The system 600 is similar to the thermoluminescent computed radiography scanning system 400 of FIG. 4 in terms of the arrangement of the various components. Specifically, a fiber optic face plate 204 sits on a CR plate 206, and a two-dimensional pixelized array 202 is sandwiched between the fiber optic face plate 204 and a heating element 208. The heating element 208 is provided with a hinge 610 which is incorporated within a mounting structure (not shown). The hinge 610 enables rotation of the heating element 208 in a direction 612. By incorporating a hinge into the heating element 208, a more standardized and repeatable heating regime can be created. This allows for easier gain corrections, and it is potentially possible to use one gain map to correct multiple image plate reads.

It should be appreciated that other hinged arrangements may be suitable, provided they are capable of creating a standardized and repeatable heating regime. For example, the hinged heating element 208 may be placed so as to first contact the CR plate 206 like the embodiment shown in FIG. 3. Further, assemblies or devices that can repeatedly place the CR plate 206 in a predetermined location may be used in conjunction with or in lieu of any hinged arrangements. For example, any kind of walled fixture allowing the image plate the heater to repeatedly go to the same locations each time would be suitable.

With each of the embodiments schematically illustrated in FIGS. 3-7, the light captured by the two-dimensional pixelized array 202 is captured two-dimensionally. Such a capture is much faster than the one-dimensional scanning of photodiodes by lasers as is done in conventional CR scanning systems. Additionally, more of the light stored in the phosphor is releasable in these embodiments, thus potentially providing a higher image quality result and/or potentially lower X-ray doses due to more information being obtained in a reasonable amount of time necessary to read the CR plate 206. This has impact on patient safety in the healthcare industry, and on throughput and radiation safety in the inspection and security industries.

Once the two-dimensional pixelized array 202 has been read, signals are sent to a processor 250 for digitizing the image and for correcting the image for various artifacts. For example, the digitized image may be corrected for an offset signal, caused by background heat. The correction of offset signals is known; however, the offset signal correction may be larger as the heating element 208 may cause an increase in the offset level. Further, the digitized image can be corrected for noise stemming from variations in the CR plate 206, variations in the pixels, and variations in the X-ray beam that formed the latent image in the CR plate 206 initially.

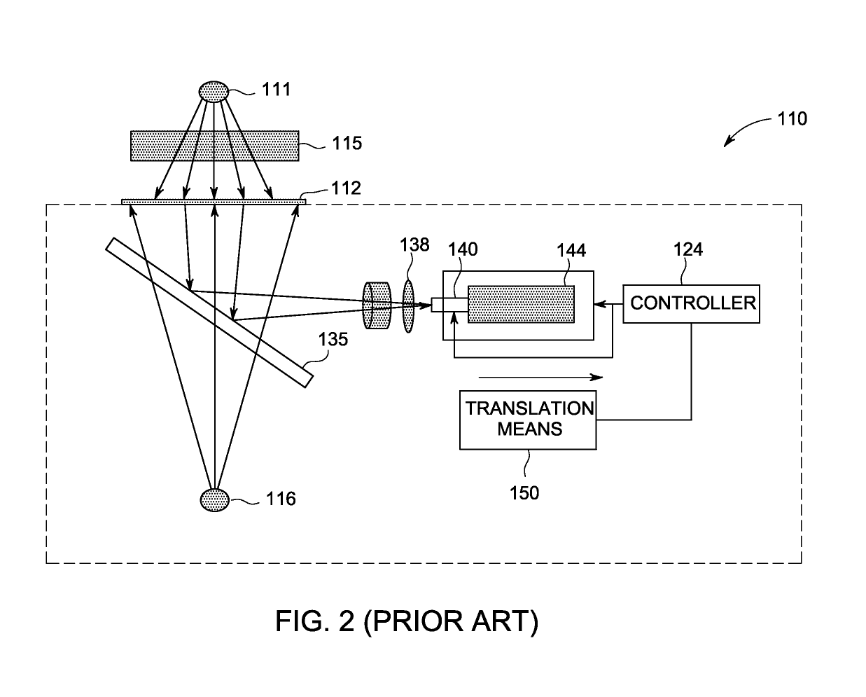

The embodiments schematically illustrated in FIGS. 3-7 provide much enhanced collection of light from CR plates. On the order of about 0.1 percent of light can be collected by lenses, such as the lenses of the conventional CR scanning system of FIG. 2. The scanning systems of FIGS. 3-7 can collect on the order of about 30 to 50 percent of the light. This enhanced light collection ability provides a better signal to noise ratio, allows for faster reading, and allows for more energy to be captured. Further, the enhanced light collection ability can lead to a lower x-ray dosage and/or a shorter needed x-ray exposure time, which can be important for patients for systems used in the medical scanning area.

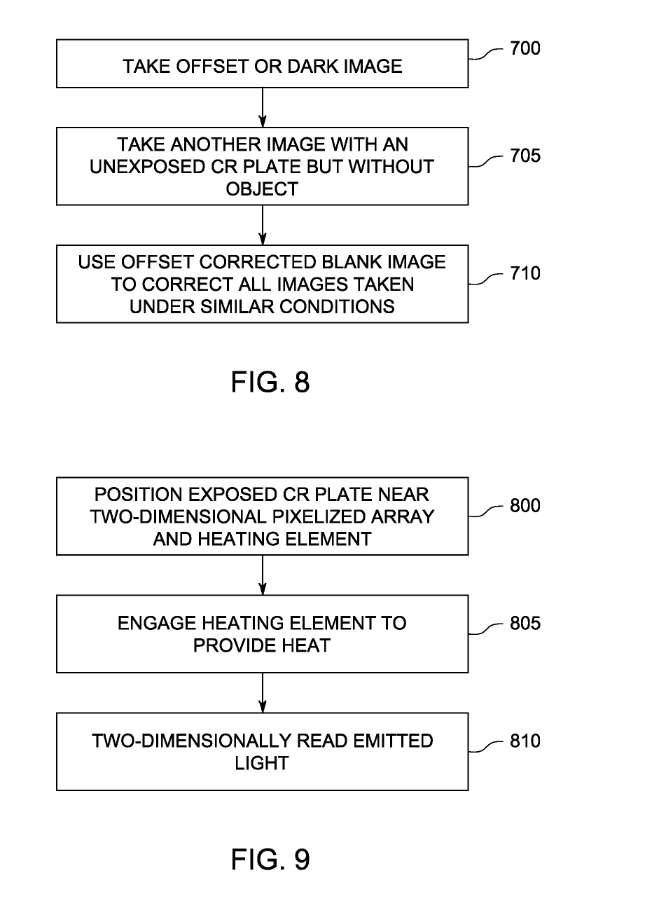

With specific reference to FIG. 8, next will be described a method for correcting for variations within images taken with the CR plate 206 and captured by the two-dimensional pixelized array 202. At Step 700, an offset image, also known as a dark image, is taken. The offset image is taken with no light on the CR plate 206. The dark image should be taken at the same conditions—exposure time, detector settings, applied heat—as subsequent images will be taken. A digitized dark image can be used to subtract out offset variations in subsequent digitized images. The digitized dark image can be stored for future use.

Next, at Step 705, another image, known as a blank image, is taken with a computed radiography phosphor but without an object. By subtracting the digitized dark image from a digitized blank image, an offset corrected blank image is created. The digitized offset corrected blank image can be stored and, at Step 710, used to correct all digitized images taken under similar conditions. In operation, a digitized dark image is subtracted from a digitized object image to create an offset corrected object image. Then, the digitized offset corrected object image is divided by a digitized offset corrected blank image to create a finalized digitized object image. The finalized digitized image can be multiplied by a constant to return the signal level to a value that is close to the initial offset corrected object image value. Now, however, the pixel-to-pixel variations inherent in the camera or due to an uneven heat source have been significantly reduced. This constant can be obtained by taking the mean of the offset corrected blank image.

Next, with specific reference to FIG. 9 and general reference to FIGS. 3-8, will be described a method for reading, digitizing and correcting for variations in an image in accordance with an embodiment of the invention. First, at Step 800 an exposed CR plate, such as CR plate 206 is positioned in optical contact, either directly or through a fiber optic faceplate, with a two-dimensional pixelized array, such as two-dimensional pixelized array 202, and a heating element, such as heating element 208. The CR plate may be positioned between the two-dimensional pixelized array and the heating element, or the two-dimensional pixelized array may be positioned between the CR plate and the heating element. Optionally, a fiber optical face plate, such as fiber optic face plate 204, may be positioned between the two-dimensional pixelized array and the CR plate.

Then, at Step 805 the heating element is engaged to provide heat. The heating element may produce heat in a temperature range of, for example, about 50° C. to about 200° C. The heat travels from the heating element to the CR plate. The heat releases a latent image in the exposed CR plate in the form of light. Allowing the heating element to continue to heat for an extended duration will enable more light to be released from the CR plate. The released light is transmitted to the two-dimensional pixelized array, either directly or through the fiber optic face plate.

At Step 810, the two-dimensional pixelized array reads the light two-dimensionally. This is a vast improvement over the one-dimensional scanning performed by laser scanners in conventional CR scanning systems. The scanned signals are then transmitted to a processor, such as processor 250. The processor digitizes the scanned signals and stores them in a memory. Further, the processor corrects for artifacts and variations in the digitized scanned signals according with the steps listed in FIG. 8.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, while embodiments have been described in terms that may initially connote singularity, it should be appreciated that multiple components may be utilized. Further, while arrangements have been described with the computed radiography plate positioned between the two-dimensional pixelized array and the heating element and the two-dimensional pixelized array positioned between the computed radiography plate and the heating element, it should be understood that other arrangements consistent with the invention may be within the scope of the invention. For example, a heating element may be incorporated within the fiber optic face plate. Optionally, a translucent or transparent heating element may be utilized, thereby allowing the heating element to be placed anywhere within the arrangement, if the heater does not degrade the spatial resolution of the transmitted image plate to the image array. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A computed radiography reading system, comprising:
an exposed computed radiography plate;
a two-dimensional pixelized array; and
a heating element, wherein the heating element conducts heat to the computed radiography plate and the computed radiography plate releases entrained light signals to the two-dimensional pixelized array in response to the conducted heat.

2. The computed radiography reading system of claim 1, wherein the computed radiography plate comprises a flexible, thermoluminescent computed radiography phosphor.

3. The computed radiography reading system of claim 1, wherein the two-dimensional pixelized array comprises an amorphous silicon array.

4. The computed radiography reading system of claim 1, wherein the two-dimensional pixelized array comprises a plurality of tiled crystalline or amorphous silicon panels.

5. The computed radiography reading system of claim 1, wherein the heating element comprises a polyimide insulated heater or a hot plate.

6. The computed radiography reading system of claim 1, wherein the computed radiography plate is positioned between the two-dimensional pixelized array and the heating element or the two-dimensional pixelized array is positioned between the computed radiography plate and the heating element.

7. The computed radiography reading system of claim 1, comprising a fiber optic face plate positioned between the computed radiography plate and the two-dimensional pixelized array.

8. The computed radiography reading system of claim 1, comprising a hinge, wherein the heating element is mounted on the hinge.

9. The computed radiography reading system of claim 1, comprising a processor for digitizing the light signals received by the two-dimensional pixelized array.

10. A thermoluminescent computed radiography reading system, comprising:
an exposed, flexible, thermoluminescent computed radiography phosphor;
an amorphous silicon based two-dimensional pixelized array; and
a heating element, wherein the heating element conducts heat to the computed radiography phosphor and the computed radiography phosphor releases entrained light signals to the two-dimensional pixelized array in response to the conducted heat.

11. The thermoluminescent computed radiography reading system of claim 10, wherein the computed radiography phosphor is positioned between the two-dimensional pixelized array and the heating element or the two-dimensional pixelized array is positioned between the computed radiography phosphor and the heating element.

12. The thermoluminescent computed radiography reading system of claim 10, comprising a fiber optic face plate positioned between the computed radiography phosphor and the two-dimensional pixelized array.

13. The thermoluminescent computed radiography reading system of claim 10, comprising a hinge, wherein the heating element is mounted on the hinge.

14. The thermoluminescent computed radiography reading system of claim 1, comprising a processor for digitizing the light signals received by the two-dimensional pixelized array.

15. A method, comprising:
placing an exposed computed radiography plate near to a two-dimensional pixelized array and a heating element;
conducting heat toward the exposed computed radiography plate to release trapped light from the exposed computed radiography plate; and
receiving the released light in the two-dimensional pixelized array to store an image therein.

16. The method of claim 15, wherein said placing comprises placing the exposed computed radiography plate between the two-dimensional pixelized array and the heating element.

17. The method of claim 16, wherein the heating element is hinged.

18. The method of claim 16, wherein said placing comprises placing the exposed computed radiography plate adjacent to a fiber optic face plate.

19. The method of claim 15, comprising digitizing the image stored in the two-dimensional pixelized array.

20. The method of claim 19, comprising correcting for variations in the digitized image, wherein said correcting comprises:
creating an offset image;
creating a blank image with an unexposed computed radiography plate without an object;
digitizing the offset and blank images;
subtracting the digitized offset image from the digitized image to form a digitized offset corrected object image;
subtracting the digitized offset image from the digitized blank image to form a digitized offset corrected blank image; and
dividing the digitized offset corrected object image by the digitized offset corrected blank image to form a finalized digitized image.
